(19) United States
(12) Patent Application Publication
(10) Pub. No.: US 2004/0049729 A1
(43) Pub. Date: Mar. 11, 2004

(54) Computer-based statistical analysis method and system

(75) Inventor: Randall D. Penfield, Gainesville, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: University of Florida, Gainesville, FL

(21) Appl. No.: 10/238,552

(22) Filed: Sep. 10, 2002

(51) Int. Cl. G06F 15/00

(52) U.S. Cl. 715/503; 715/504

(57) ABSTRACT

A method of statistical analysis can include receiving data within a first window of a graphical user interface and executing a statistical function over a user-specified portion of the data. Within a second window of the graphical user interface, a result determined from execution of the statistical function can be presented. Interpretation rules can be applied to the result to determine an interpretation of the result. Within a third window of the graphical user interface, the interpretation of the result can be presented. The interpretation can indicate whether the result conforms to the interpretation rules.

### BACKGROUND OF THE INVENTION

1. Technical Field

The invention relates to the field of statistical analysis, and more particularly, to a computer-based statistical analysis system having a unified interface.

2. Description of the Related Art

Surveys and the analysis of survey generated data have become increasingly important in modern society. Survey data not only provides an important tool for social scientists to gauge modern culture, but also can be a significant factor in the determination of geopolitical boundaries, the acquisition of political power, the division of governmental resources, as well as how businesses choose to relate to consumers.

Survey data and other types of data such as financial transaction data, biological data, and the like, typically are analyzed using commercially available statistical processing applications which can perform a variety of statistical functions. Many conventional statistical processing applications attempt to provide ease of use through a series of graphical user interfaces (GUIs). Still, to successfully use such an application, a user must acquire substantial knowledge of the application itself, as performing many seemingly routine tasks often requires the user to navigate among a variety of different GUIs. For example, such systems can display data within one GUI, provide output within another GUI, and provide graphs and/or visual data representations within yet another GUI.

Most statistical processing applications further expect a user to be somewhat advanced, having significant knowledge in the field of statistical processing. As a result, conventional statistical processing applications are used primarily by “power users”, or those users having extensive knowledge of both statistics and software. Accordingly, non-power users such as students or researchers in various segments of industry and academia who rely on survey data, attitude scales, psychological assessments, and the like, but have limited experience with statistical processing or software packages, are not likely to resort to complex software packages.

For example, more complex software packages which assume a minimal working knowledge of statistical processing offer little guidance to users in determining suitable processing algorithms and/or functions. In the event a user applies an inappropriate statistical function to a given set of data, the user is left to interpret seemingly incorrect or nonsensical output. The software package does not provide insight as to whether the results obtained fall within accepted guidelines for the process applied. Moreover, most conventional statistical processing applications do not provide users with alternative statistical functions if the user-applied statistical function yields poor quality results.

While some statistical processing applications have attempted to simplify the user interface, this simplification has often come at the price of decreased functionality. For example, less complex statistical processing applications may lack such important features as item response theory analysis or differential item functioning analysis. In consequence, non-power users who still have a need for powerful statistical processing capabilities are unlikely to turn to tools with decreased functionality despite the ease of use of such systems.

### SUMMARY OF THE INVENTION

The invention disclosed herein provides a statistical processing system having an interface which provides users of varying experience and skill levels access to a set of comprehensive statistical functions. In particular, the present invention incorporates a single, unified graphical user interface (GUI) through which users can input data in spreadsheet format, select statistical functions to be executed, and display results of the statistical processing. Through the unified GUI, users also can select previously executed statistical functions to view previous results and any other data associated with the selected statistical function. Notably, the present invention incorporates a consultation window. The consultation window provides user feedback as well as an interpretation of the results obtained from the executed statistical function.

One aspect of the present invention can include a method of statistical analysis. The method can include receiving data within a first window of a GUI and executing a statistical function, for example performing item response theory analysis or differential item functioning analysis, over a user-specified portion of the data. Notably, the first window of the GUI can be a spreadsheet window. Within a second window of the GUI, a result determined from the execution of the statistical function can be presented. The result can be presented as a textual representation or a graphic representation responsive to the selection of an activatable icon. Interpretation rules can be applied to the result to determine an interpretation of the result. Within a third window of the GUI, the interpretation of the result can be presented. The interpretation can indicate whether the results conform to the interpretation rules.

The method further can include storing data sets having an executed statistical function, a user-specified portion of data processed by the executed statistical function, a result of the executed statistical function, and an interpretation of the result of the executed statistical function. The references corresponding to the data sets can be presented in a fourth window of the graphical user interface. Responsive to a user selection of one of the references, a user selected data set can be recalled and displayed.

According to another embodiment of the present invention, a determination can be made as to whether one or more interpretation rules has been violated. Data in the first window that is associated with the one or more violated interpretation rules can be visually distinguished from other data in the first window. Similarly, a portion of the result that is associated with one or more violated interpretation rules can be visually distinguished from other portions of the result.

One or more different statistical functions suited to process the user-specified portion of the data can be identified according to the determination of whether one or more of the interpretation rules was violated. Accordingly, a description of the different statistical functions can be presented within the third window. A sequentially ordered set of graphical user interfaces providing instructions for guiding a user through the execution of the different statistical function over the user-specified portion of the data can be presented.

Another aspect of the present invention can include an interactive statistical analysis system having a statistical processor configured to apply one or more statistical functions to data. The statistical analysis system can include a single GUI having a first data entry window, for example a spreadsheet window, for receiving the data, a second result window for presenting results determined from the application of one of the statistical functions to the data, and a third interpretation window for providing an interpretation of the results from the second window. The single GUI also can include a fourth history window. The fourth history window can be configured to present references to data sets. In particular, each data set can include an executed statistical function, a user-specified portion of data processed by the executed statistical function, a result of the executed statistical function, and an interpretation of the result of the executed statistical function.

The statistical analysis system can include a data store having interpretation rules for interpreting results from the application of one of the statistical functions to the data. The interpretation rules can be associated with particular ones of the statistical functions and can specify statistical assumptions for particular ones of the statistical functions. Additionally, if at least one of the interpretation rules is violated, the interpretation rules can specify alternate statistical functions suited to process data.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating a system for performing statistical analysis in accordance with the inventive arrangements disclosed herein.

FIG. 2 is a schematic diagram illustrating an exemplary graphical user interface for the statistical analysis system of FIG. 1.

FIG. 3 is a schematic diagram illustrating another exemplary graphical user interface for use with the statistical analysis system of FIG. 1.

FIG. 4 is a flow chart illustrating a method of performing statistical analysis in accordance with the inventive arrangements disclosed herein.

### DETAILED DESCRIPTION OF THE INVENTION

The invention disclosed herein provides a statistical processing system which provides access to a set of comprehensive statistical functions. The present invention incorporates a single, unified graphical user interface (GUI) through which users can input data in spreadsheet format, select statistical functions to be executed, and display results of the statistical processing. The unified GUI also provides access to previously executed statistical functions, results, and data used during the statistical functions. Notably, the present invention incorporates a consultation window which provides an interpretation of the statistical processing performed and the results obtained.

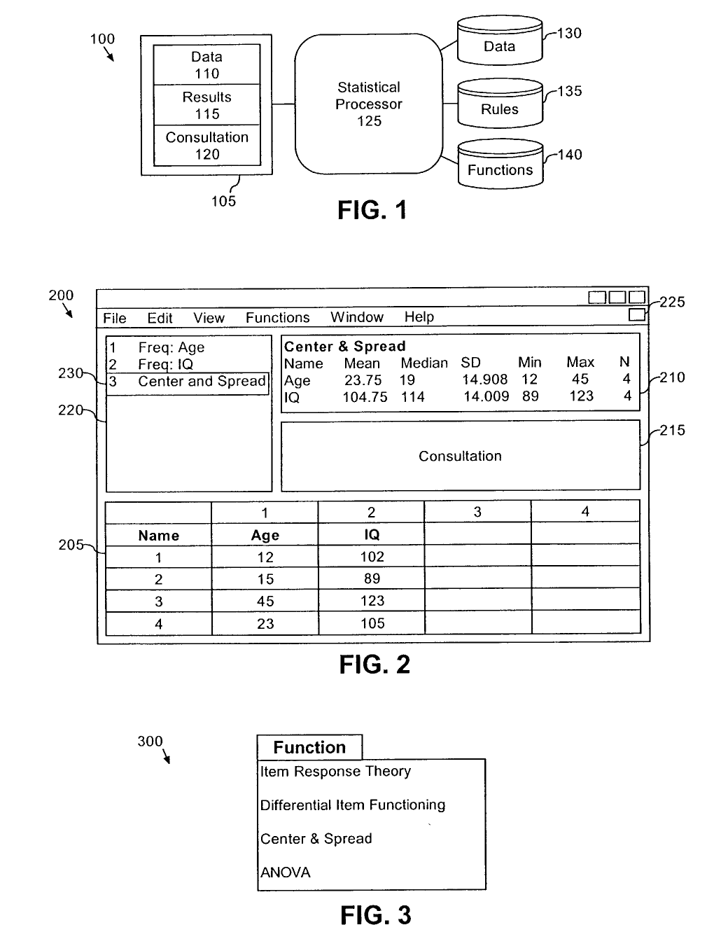

FIG. 1 is a schematic diagram illustrating a system 100 for performing statistical analysis in accordance with the inventive arrangements disclosed herein. As shown in FIG. 1, the system 100 can include a GUI 105, a statistical processor 125, and several data stores 130, 135, and 140. The GUI 105 can be a single, unified interface for receiving input and providing various forms of output to a user. In particular, the GUI 105 can include a data window 110, a results window 115, and a consultation window 120. The data window 1 10 can receive data to be processed by the system 100 from a user. The results window 115 can present the output of any statistical processing performed by system 100. The consultation window 120 provides the user with feedback with regard to the results of any statistical processing performed. For example, within the consultation window, the system 100 can inform the user as to whether the results obtained are relevant, whether another statistical function would be better suited to process the input data, and/or whether any fundamental assumptions with regard to the operation of the executed function or analysis have been violated.

The statistical processor 125 can be communicatively linked to the GUI 105 such that data to be processed can be received from the GUI 105, for example from the data window 110. Similarly, statistical processing results and interpretations to be presented in the results window 115 and consultation window 120 can be provided to the GUI 105 for communication to a user. The statistical processor 125 can be configured to execute one or more of a variety of basic and more complex statistical analysis functions. For example, the statistical processor can determine descriptive univariate statistics such as mean, standard deviation, percentages, and the like; measures of bivariate association such as correlation and chi-square tests of independence; group difference in means such as one-sample z-tests, one and two sample t-tests, and confidence intervals for means; analysis of variance (ANOVA) between groups, and linear regression. Regarding more complex statistical analysis functions, the processor 125 can be configured to perform one or more psychometric calculations such as factor analysis, principal components analysis, multivariate scaling, classical reliability and item analysis, item response theory (IRT) analysis, and differential item functioning (DIF) analysis.

In addition, the statistical processor can analyze statistical processing results to determine whether the results received conform to specified tolerances associated with the various statistical functions performed, as well as whether any assumptions regarding the statistical functions were violated during processing. Accordingly, based upon the analysis, the statistical processor 125 can determine whether one or more other statistical functions would be better suited to process the data.

The statistical processor can be communicatively linked to the various data stores 130, 135, and 140. The data store 130 can store any information to be processed. For example, any information received through the data window 110 of the GUI 105 can be stored within the data store 130. Notably, any statistical processing results and interpretations also can be stored for future reference and access. The interpretation rules data store 135 can specify one or more function specific interpretation rules for analyzing any determined statistical processing results. In particular, the interpretation rules can specify tolerances within which the results should fall. Any results not falling within specified tolerances can indicate that a fundamental assumption for the function that was executed was not followed. Notably, the interpretation rules can specify one or more alternative statistical functions for particular cases where results do not fall within specified tolerances. The functions data store 140 can include a variety of configurable or pre-configured statistical functions which can be accessed by the statistical processor 125 and executed. Thus, the statistical functions which can be performed by the statistical processor 125 such as standard deviation, determining the mean value, the median value, and performing IRT analysis and/or DIF analysis can be defined within the functions data store 140.

FIG. 2 is a schematic diagram illustrating an exemplary GUI 200 for the statistical analysis system of FIG. 1. As shown, the GUI 200 can include a data entry window 205, a results window 210, a consultation window 215, and a history window 220. Notably, the GUI can include one or more toolbars (not shown) which provide direct access to particular statistical functions. In addition, one or more various browser style navigation buttons such as “forward” and “back” can be included.

The data entry window 205 can receive data to be processed by the statistical analysis system. In particular, the data entry window 205 can be a spreadsheet having rows and columns of related data. For example, as illustrated in FIG. 2, the data entry window 205 lists age and IQ data relating to four different subjects, wherein individual subjects correspond to rows of the spreadsheet and subject parameters correspond to columns of the spreadsheet. It should be appreciated that data can be entered cell by cell as can be done with a conventional spreadsheet. Alternatively, data can be imported and/or opened as also can be done with conventional spreadsheet applications.

The results window 210 provides results from the application of one or more statistical functions. For example, the results window 210 provides the statistical results from a “center and spread” set of functions or analysis. That is, the present invention can provide center and spread as a statistical processing option. The center and spread option can include several different statistical functions grouped together so as to provide a more complete picture of the processed data. Thus, the center and spread analysis in general provides a measure of the centrality of the data. As shown, the center and spread analysis can include mean, median, standard deviation, minimum, maximum, and number of item calculations.

The results in the result window 210 can be shown in one of two different formats. The results can be presented in graphic form, for example, as a color graphic of a table or a graph which can be exported to another program as a picture. Alternatively, the results can be presented in text form such that the output can be exported as a text file. Notably, activatable icon 225 allows a user to switch back and forth between the two modes of output. Accordingly, responsive to selection of the activatable icon 225, the results presented in the results window can be presented in text or graphic form. According to another aspect of the invention, the results can be presented in both text and graphic form, for example by selecting activatable icon 225 a third time. The results can be exported in the format displayed in the results window when an export option is selected or a selection control can be provided to the user during the export operation.

The consultation window 215 can provide the user with an interpretation of the results. The interpretation can notify the user as to whether the results shown in the results window 210 conform to one or more interpretation rules. The interpretation rules can be specified on a per function basis, and accordingly, can specify tolerances to which the data as well as the results are to conform. The interpretation rules further can specify alternate functions which may be more suitable for processing a given set of data. For example, the interpretation rules can specify preferred tolerance ranges for results determined by a particular statistical function. The interpretation rules also can specify less preferred and/or incorrect ranges and associated alternate functions and/or data processing strategies which can be provided or suggested to the user in the event that the results fall within such a delineated range.

The history window 220 can provide the user with a history or listing of the various statistical functions which have been applied to a given selection of data. Each statistical function executed, the actual data processed by the statistical function, the result, and interpretation can be stored as a history data set along with a reference to the history data set. The histories can be stored on a per statistical function basis, and thus, can store all functions, data, results, and interpretations executed and/or generated during a given statistical processing session. The references to the history data sets can be displayed in the history window 220. Accordingly, a history data set can be accessed by selection of one of the references in the history window 220. As shown in the history window 220, the user has executed a frequency function on age and IQ parameters. The user also has executed a center and spread analysis.

Rather than displaying an ongoing page of all output corresponding to a given statistical processing session, the statistical analysis system of the present invention presents input and output for a single statistical function or analysis at any given time. Thus, the history window 220 permits the user to jump back and forth between any previously executed function and/or analysis by selecting the appropriate history reference. Accordingly, selection of any displayed history reference causes the recall of the data used by a statistical function, the statistical function itself, results, and interpretation belonging to the history data set associated with the selected history reference.

Notably, if a user provides data in the data entry window 205, executes the center and spread analysis, the data used for the statistical function, the statistical function itself, determined results displayed in the results window 210, and interpretations displayed in the consultation window 215 can be saved. Accordingly, by selecting item 230 corresponding to option 3, the center and spread option from the history window 220, all data associated with the execution of that function can be recalled and displayed in the appropriate window. It should be appreciated that any changes to the data can be stored as well. Thus, if the data changes between execution of the frequency calculations for age and IQ, the exact data set used in the execution of the statistical function can be recalled.

Other options can be included to re-execute a prior executed statistical function on changed data using the parameters established during the prior execution of the statistical function. Also, multiple executions of the same statistical function or analysis can be stored and shown in the history window 220 whether or not each execution uses a different version of the data set.

FIG. 3 is a schematic diagram illustrating another exemplary GUI 300 for use with the statistical analysis system of FIG. 1. The GUI 300 illustrates a drop-down style menu which can be displayed after user selection of the “Function” option. The GUI 300 can list statistical functions or analyses such as IRT analysis, DIF analysis, ANOVA, and center and spread analysis, as well as any other statistical functions or analyses which may be available for processing entered data.

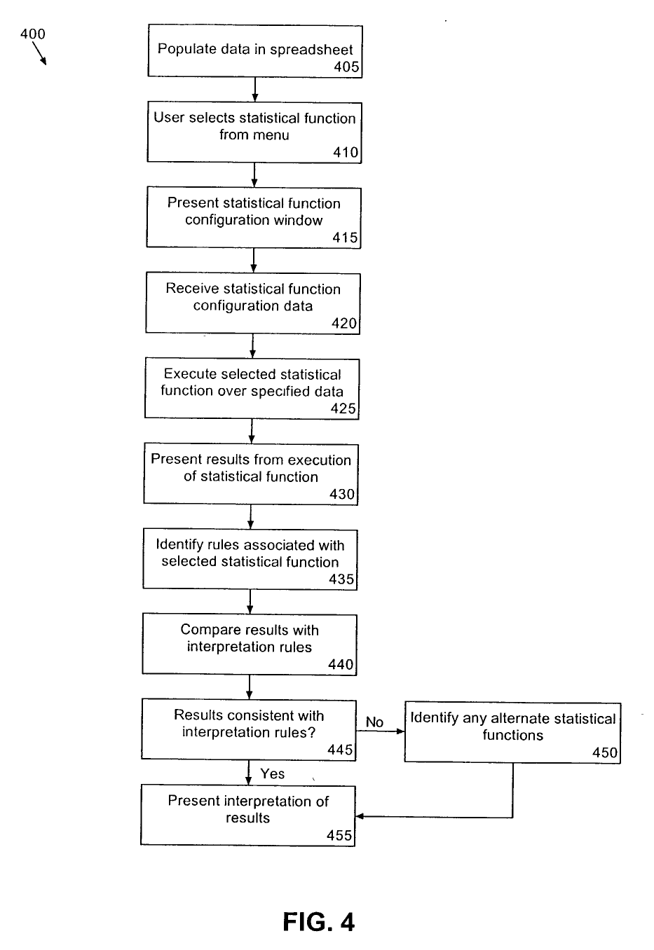

FIG. 4 is a flow chart illustrating a method 400 of performing statistical analysis in accordance with the inventive arrangements disclosed herein. Beginning in step 405, the spreadsheet data entry window can be populated with data. As mentioned, data can be manually entered into the window or can be imported from one or more external sources. In step 410, the user can select a statistical function or a group of statistical functions to be executed on the data. For example, the user can select a function from a icon on a toolbar or can select a statistical function from the function menu.

In step 415, the user can be presented with a statistical function configuration GUI. Within the configuration GUI, the user can specify those rows, columns, and/or individual cells of data to be processed by the selected statistical function or analysis. In any case, the user also can specify any required parameters, for example if the selected function is a recursive function, the user can specify a number of iterations to be performed or other aspects of the function. Still, as the present invention can be used by users of varying computer and mathematical skill levels, default values can be specified. It should be appreciated, however, that the user may highlight rows, columns, and/or individual cells prior to or after the selection of a statistical function. In that case, the function can be executed over the specified data so long as the specified data conforms to the required input for the statistical function. For example, to determine a mean, the user need only select the column for which the user desires the mean.

In step 420, the configuration data can be received by the statistical processing system. For example, a highlighted portion of data can be identified responsive to the selection of a statistical function or data can be identified responsive to the user selecting “OK” from the configuration GUI discussed in step 415. In any case, in step 425, the selected statistical function can be executed over the specified data range. In step 430, the results obtained from processing the designated data with the selected statistical function can be presented in the results window.

The interpretation rules associated with the selected statistical function can be identified in step 435. Notably, the proper interpretation rules can be identified at or around the same time as the user selects a particular statistical function. In any case, as noted, the identified interpretation rules are specific to the selected statistical function. As such, the interpretation rules can specify tolerances for particular variables, parameters, and/or results. The various parameter and result tolerance ranges specified by the interpretation rules can be associated with alternative statistical functions, helpful suggestions, data processing strategies and/or explanations.

In step 440, the results can be compared against the identified interpretation rules. In step 445, a determination can be made as to whether the results are consistent with the interpretation rules. If so, the method can proceed to step 455. If not, however, the method can continue to step 450. In step 450, the statistical processing system can determine which, if any, interpretation rules were violated. The statistical processing system can determine which underlying assumptions were violated with regard to the data, whether the results of the selected statistical function provide an accurate assessment of the data, any alternative statistical functions which can be applied to the data, any suggested strategies, and the like.

Accordingly, the interpretation can be presented in the consultation window in step 455. If the results were consistent with the interpretation rules, the user can be so notified. Additional information such as suggested additional statistical processing strategies and additional statistical functions can be suggested. If the results were not consistent with the interpretation rules, however, the user can be notified of the inconsistency and that the results likely do not provide an accurate or reliable assessment of the data. In that case, additional information describing why the results were found to be inconsistent with the interpretation rules can be provided. In addition, the user can be notified as to which assumptions and/or interpretation rules were violated, the degree to which the results were found to be out of suggested tolerances, as well as any alternative statistical functions, strategies and/or supplemental and trouble-shooting information.

The following examples are provided as illustrations of the consultation window of the present invention as well as the interpretations which can be presented therein.

As discussed, the center and spread analysis can determine descriptive statistics relating to the centrality of the variable distributions. For each variable included in the analysis, the mean, median, minimum value, maximum value, standard deviation, and number of cases can be determined. The statistical processor can determine an interpretation of the results. In particular, for each variable in the analysis, the statistical processor can determine whether any values are outliers, whether the distribution is skewed, and whether the distribution is normal.

In determining whether any values are outliers, outliers can be specified as an observation whose value lies either more than 3 semi-interquartile ranges above the value of the third quartile, or more than 3 semi-interquartile ranges below the value of the first quartile. It should be appreciated that the various limits, ranges, and thresholds disclosed herein can be predetermined or can be configured by a user or administrator.

If a value is determined to be an outlier, the statistical processor can determine the degree to which the presence of the outlier influences the mean. If the degree of influence is large, the observation can be flagged or visually distinguished. Accordingly, a user can be notified of which observations are outliers, which observations have a large influence on the mean, and if any outliers have a large enough influence, recommend that the median may be a more accurate measure of center than the mean.

As noted, data or results not conforming to one or more interpretation rules can be visually distinguished. For example, a particular column or row of data as well as individual cells can be highlighted or color coded to indicate the problem, broken assumption, or interpretation rule associated with the visually distinguished data.

Similarly, the result can be color coded, highlighted, or otherwise visually distinguished, whether the distinguished portion of the result is a portion of text or a portion of a graphic illustration as previously discussed.

If the distribution is skewed, where the skew can be evaluated by considering the third moment about the mean, the user can be so notified. The user also can be notified that the median should be used as an index of distribution center. If the distribution is normal, the user can be so notified. The distribution can be evaluated using a combination of skew and kurtosis. If large deviations of the skew and kurtosis measures from those observed for normal deviations exist, the user can be notified that the distribution deviates substantially from normal. If not, the user can be notified that the distribution approximates a normal distribution.

Continuing with the center and spread example where an age variable and an IQ variable are included within an analysis, the following is a possible and exemplary interpretation which can be presented in the consultation window.

Age: Age has 2 observations that have been flagged as outliers. These observations are located in rows 25 and 32 of the data editor. Because one or more of these outliers has a large influence on the mean, the use of the median as an index of center is recommended. Age is positively skewed, indicating that the median should be used as an index of center. The distribution of Age deviates substantially form a normal distribution.

IQ: IQ has 0 observations that have been flagged as outliers. IQ is approximately symmetric, indicating that the mean can be used as an index of center. The distribution of IQ approximates a normal distribution.

Taking another example, IRT analysis computes the relevant item parameters using one of several user selected methods such as maximum likelihood or marginal maximum likelihood; the trait level of the row (person) using one of several user selected methods such as maximum likelihood or Bayesian; the fit of the item, the item and scale information; and asymptotic standard error. For each variable included in the analysis, one or more interpretation rules can be applied to the data and results to determine an interpretation to be presented in the consultation window.

For example, a determination can be made as to whether items are fitting the present model. If so, the user can be so notified. If not, the statistical processor can examine the lack of fit trend and use this information to propose alternative IRT models that may provide a better fit. Any estimates that did not converge can be identified. The user can be notified of any estimates that did not converge and can be advised to interpret the value of the parameter with caution. The expected level of error observed in each item parameter can be determined. Additionally, the level of trait that will have the most accurate estimate as well as the expected error of the estimate can be determined and presented in the consultation window.

Continuing with the IRT example, the following is a possible and exemplary interpretation which can be presented in the consultation window.

Item 1: Item 1 displays significant lack of fit, and the trend of the lack of fit indicates that a higher discrimination parameter would lead to improved fit. There is 95% confidence that the true value of b1 is between −0.2 and +0.65. Item 1 provides the most information of individuals with trait levels near 0.28.

Item 2: Item 2 displays good fit. There is 95% confidence that the true value of b1 is between 0.5 and 1.1. Item 2 provides the most information for individuals with trait levels near 0.8.

The invention disclosed herein provides a statistical processing system having a single, unified GUI thereby enabling users of varying experience and skill levels access to a set of comprehensive statistical functions. The unified GUI can display data to be processed in spreadsheet format, display results as text or images, present an interpretation of the results, and provide a selectable history list of statistical functions and analyses performed.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of statistical analysis comprising:
receiving data within a first window of a graphical user interface;
executing a statistical function over a user-specified portion of said data;
presenting within a second window of said graphical user interface a result determined from said execution of said statistical function;
applying interpretation rules to said result to determine an interpretation of said result; and
presenting within a third window of said graphical user interface said interpretation, said interpretation indicating whether said result conforms to said interpretation rules.

2. The method of claim 1, wherein said first window is a spreadsheet window.

3. The method of claim 1, further comprising:
responsive to selection of an activatable icon, selectively presenting said result as a textual representation or as a graphic representation.

4. The method of claim 1, further comprising:
storing data sets comprising an executed statistical function, a user-specified portion of data processed by said executed statistical function, a result of said executed statistical function, and an interpretation of said result of said executed statistical function;
presenting references corresponding to said data sets in a fourth window of said graphical user interface; and
recalling a user selected data set and displaying said selected data set responsive to a user selection of one of said references.

5. The method of claim 1, wherein said statistical function is at least one of an item response theory analysis and a differential item functioning analysis.

6. The method of claim 1, said applying step comprising:
determining whether at least one of said interpretation rules has been violated.

7. The method of claim 6, further comprising:
visually distinguishing data in said first window that is associated with said at least one violated interpretation rule from other data in said first window.

8. The method of claim 6, further comprising:
visually distinguishing a portion of said result that is associated with said at least one violated interpretation rule from other portions of said result.

9. The method of claim 6, said presenting step further comprising:
identifying at least one different statistical function suited to process said user-specified portion of said data according to said determination of whether at least one of said interpretation rules has been violated.

10. The method of claim 9, said presenting step further comprising:
presenting a description of said different statistical function within said third window.

11. The method of claim 10, said presenting step further comprising:
presenting a sequentially ordered set of graphical user interfaces providing instructions for guiding a user through the execution of said different statistical function over said user-specified portion of said data.

12. An interactive statistical analysis system comprising:
a statistical processor configured to apply at least one of a plurality of statistical functions to data; and a single graphical user interface comprising a first data entry window for receiving said data, a second result window for presenting results determined from the application of one of said plurality of statistical functions to said data, and a third interpretation window for providing an interpretation of said results from said second window.

13. The interactive statistical analysis system of claim 12, wherein said first data entry window is a spreadsheet window.

14. The interactive statistical analysis system of claim 12, further comprising:
a data store having interpretation rules for interpreting results from said application of one of said plurality of statistical functions to said data, wherein said interpretation rules are associated with particular ones of said plurality of statistical functions.

15. The interactive statistical analysis system of claim 14, wherein said interpretation rules further specify statistical assumptions for particular ones of said plurality of statistical functions.

16. The interactive statistical analysis system of claim 15, wherein if at least one of said interpretation rules is violated, said interpretation rules specify alternate statistical functions suited to process data.

17. The interactive statistical analysis system of claim 16, said single graphical user interface further comprising:
a fourth history window configured to present references to data sets, wherein each said data set comprises an executed statistical function, a user-specified portion of data processed by said executed statistical function, a result of said executed statistical function, and an interpretation of said result of said executed statistical function.

18. A machine-readable storage, having stored thereon a computer program having a plurality of code sections executable by a machine for causing the machine to perform the steps of:
receiving data within a first window of a graphical user interface; executing a statistical function over a user-specified portion of said data; presenting within a second window of said graphical user interface a result determined from said execution of said statistical function;
applying interpretation rules to said result to determine an interpretation of said result; and
presenting within a third window of said graphical user interface said interpretation, said interpretation indicating whether said result conforms to said interpretation rules.

19. The machine-readable storage of claim 18, wherein said first window is a spreadsheet window.

20. The machine-readable storage of claim 18, further comprising:
responsive to selection of an activatable icon, selectively presenting said result as a textual representation or as a graphic representation.

21. The machine-readable storage of claim 18, further comprising:
storing data sets comprising an executed statistical function, a user-specified portion of data processed by said executed statistical function, a result of said executed statistical function, and an interpretation of said result of said executed statistical function;
presenting references corresponding to said data sets in a fourth window of said graphical user interface; and
recalling a user selected data set and displaying said selected data set responsive to a user selection of one of said references.

22. The machine-readable storage of claim 18, wherein said statistical function is at least one of an item response theory analysis and a differential item functioning analysis.

23. The machine-readable storage of claim 18, said applying step comprising:
determining whether at least one of said interpretation rules has been violated.

24. The machine-readable storage of claim 23, further comprising:
visually distinguishing data in said first window that is associated with said at least one violated interpretation rule from other data in said first window.

25. The machine-readable storage of claim 23, further comprising:
visually distinguishing a portion of said result that is associated with said at least one violated interpretation rule from other portions of said result.

26. The machine-readable storage of claim 23, said presenting step further comprising:
identifying at least one different statistical function suited to process said user-specified portion of said data according to said determination of whether at least one of said interpretation rules has been violated.

27. The machine-readable storage of claim 26, said presenting step further comprising:
presenting a description of said different statistical function within said third window.

28. The machine-readable storage of claim 27, said presenting step further comprising:
presenting a sequentially ordered set of graphical user interfaces providing instructions for guiding a user through the execution of said different statistical function over said user-specified portion of said data.
